(19) United States
(12) Patent Application Publication
(10) Pub. No.: US 2017/0181578 A1
(43) Pub. Date: Jun. 29, 2017

(54) Easy Starter Charcoal Box

(71) Applicant: Mario Alberto Alanis Moreno, Allende (MX)

(72) Inventor: Mario Alberto Alanis Moreno, Allende (MX)

(21) Appl. No.: 14/998,389

(22) Filed: Dec. 28, 2015

(51) Int. Cl. A47J 37/07; C10L 11/04; C10L 5/34

(52) U.S. Cl. CPC A47J 37/079; C10L 5/34; C10L 11/04; C10L 2270/08

(57) ABSTRACT

A device and method with easy starter charcoal which is a quick, convenient, reliable, odorless and non-toxic alternative to using bagged charcoal. This product is safe and will not diminish or alter the unique charcoal flavor of the foods being cooked over the charcoal. The process to start a fire from charcoal is eliminated. This product provides a one step process to start a charcoal fire. It offers a one-container method.

### I. FIELD

The present subject matter relates to the packaging and usage of charcoal briquettes or natural charcoal and fire starters.

### II. BACKGROUND

Outdoor barbeque cooking is very popular and has become a tradition and part of many social gatherings in various regions and particularly in North America. Even though, gas grills have become very popular and are easy to use the grilled foods lack the smell and unique flavor of charcoal.

For many, cooking with charcoal, and charcoal briquettes remains the preferred method of outdoor cooking. Cooking with charcoal, the smell of food cooking over an open grill, and the taste of food that was cooked over the red-hot embers, are some of the reasons for its continued popularity.

Charcoal is commercially available in several formats, including lump (natural) charcoal, charcoal briquettes, and pre-soaked charcoal briquettes.

Lump (natural) charcoal is usually random sized chunks of pre-burned hardwood and has the positive element of easy and fast ignition. However, lump (natural) charcoal also has short life span. After ignition, additional chunks usually need to be added during the cooking process.

Charcoal briquettes are usually uniform sized units made from compressed charred hardwood, or other organic materials. They are an excellent efficient fuel for cooking as they provide consistent heat, and stay lit for a long period of time. However, they are difficult to ignite due to their dense composition. Simply lighting with a match does not provide enough energy to ignite the briquettes. Therefore, lighter fluid or other harmful and toxic chemicals are typically used to ignite the briquettes. Additionally, these harmful lighting fluids or chemicals leave a residue on the briquettes if not completely burned off.

This residue alters the taste of the food while it is being cooked, leaving an unwanted flavor. Inevitably, these chemicals deposit a grade of toxicity to the cooked food.

Pre-soaked charcoal briquettes are also marketed under various names such as “easy lite.” These briquettes are composed the same as untreated charcoal briquettes but are also infused with starter fluid for easier lighting. These fluids create the same toxic problems as described above. In addition, it takes at least thirty minutes for the foul odor to dissipate. Furthermore, even these infused briquettes will need additional starter fluids to be poured onto the briquettes, as with traditional charcoal briquettes, for complete ignition of all briquettes.

Charcoal briquettes are available in bags of between five to forty pounds making them heavy and awkward to lift and transport. Additionally, the bags only contain charcoal briquettes, which means that the starter substance would need to be purchased separately. The charcoal briquettes then need to be transferred from the bag to the grill, which is an extra operation. This operation is very messy, awkward, and invariably results in inaccurate quantities of charcoal being distributed. An additional level of inconvenience and difficulty is added if the barbeque is in a remote location or on a vessel. Each trip requires a bag of charcoal and the sufficient starter substance.

### III. SUMMARY

An innovative product and method consisting of a cardboard box containing lump charcoal, which once ignited will permit an effective blaze oxygenation through the strategically located high temperature fuse allowing direct contact with the charcoal. This provides and efficient, effortless and ecologically friendly way to start a fire from charcoal.

### IV. BRIEF DESCRIPTIONS OF DRAWINGS

The drawings depict example designs and features of the product.

FIGS. 1a and 1b: A rectangular box with an opening in the front central inferior part of the box. The box will contain charcoal strategically placed to facilitate ignition. The box will include 2 high temperature fuses made of turpentine or a material similar to the high temperature characteristics of turpentine. One of the fusses will be attached to the interior of the box, which will ensure a direct flame to the charcoal. The second will be placed somewhere within the box for easy access.

FIG. 2: A tridimensional drawing showing the perforated line on box for easy opening and exposing of included charcoal.

FIG. 3: A tridimensional drawing of Easy Starter Charcoal Box showing the placement of the high temperature fuse and ignition procedure.

FIG. 4: A tridimensional drawing showing the started fire and ventilation procedure.

FIG. 5: A drawing showing the disassembled box with most efficient dimensions.

### V. DETAILED DESCRIPTION OF DRAWINGS

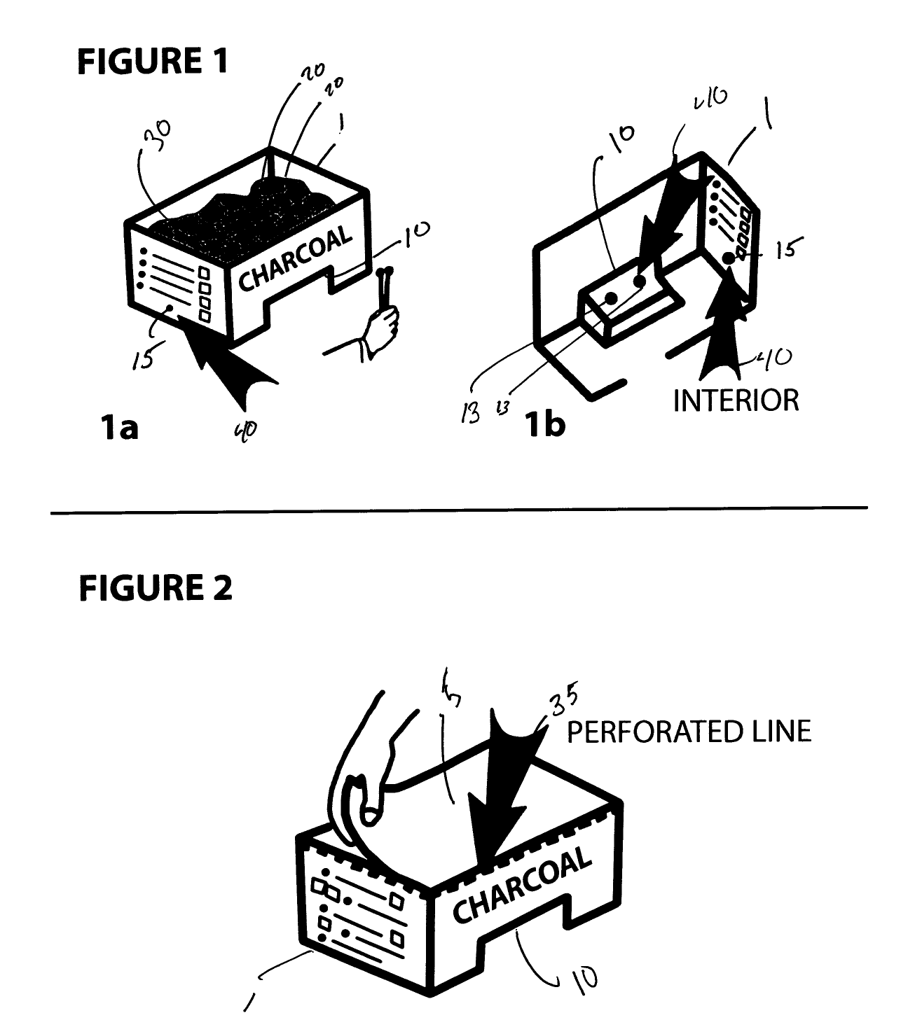

FIG. 1a: The exterior of a Rectangular box 1 with opening 10 in the front inferior part. This opening is in the form of a smaller interior box 11. The Box 1 has an orifice 15 placed on one side of the box. This orifice will have perforated lines so when the user can leave an opening for the flow of air. The box includes 2 high temperature fuses 20. The Box 1 comes with charcoal packed in a way that will allow the creation of heat to start the burning process.

FIG. 1b: shows a partial three dimensional interior view of the rectangular box 1 showing the small interior box 11 with interior small box orifices 13. Interior small box orifices 13 have perforated lines so that a high temperature fuse can be inserted through them. It also shows orifice 15 that will be perforated in order to allow air 40 to go through it.

FIG. 2 shows rectangular box 1 with a cap 5 with perforated lines 35. Opening 10 is placed opposite to cap 5. Cap 5 should be made of a material that will have enough rigidity in order to be used later as a fan. Perforated Lines 35 are placed in a way that will allow for cap 5 to be removed easily with out the need of any tools.

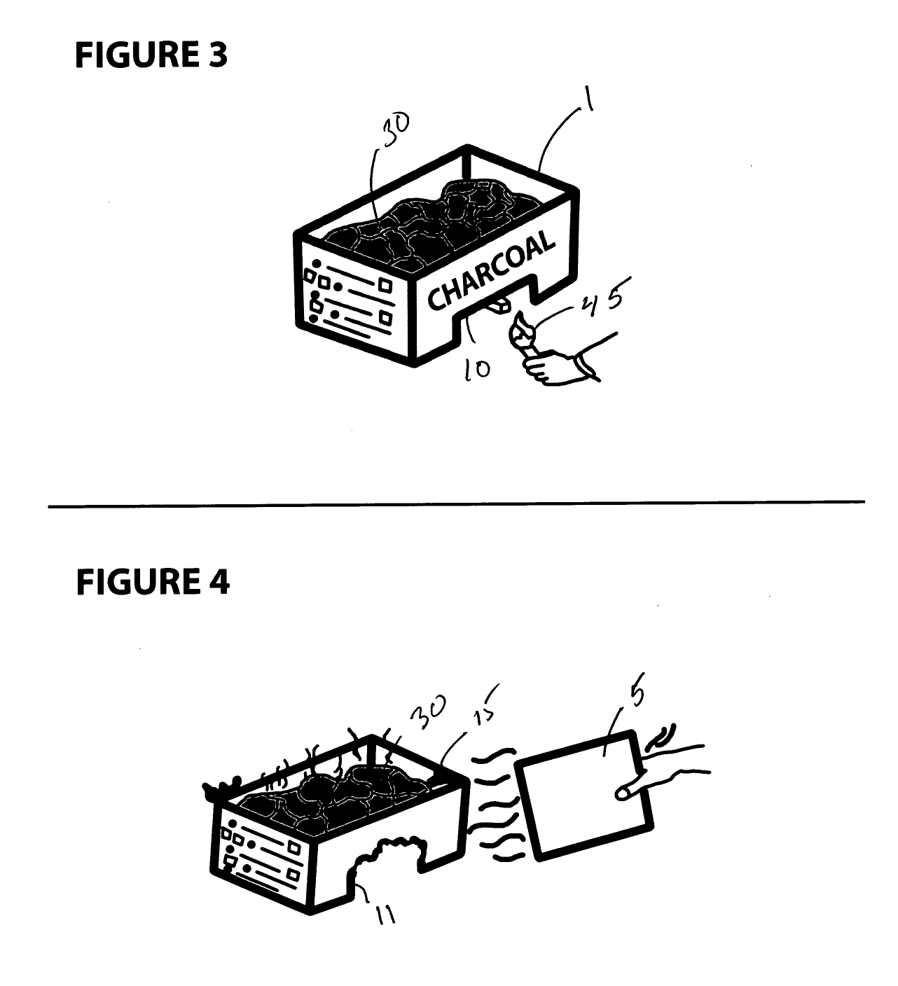

FIG. 3 shows the rectangular box 1 with out the cap 5 with a high temperature fuse 20 installed in one or the two small box orifices 13 (not shown). The charcoal 30 is properly exposed to the outdoor elements. A lighting mechanism 45, such as a match or lighter will the be used to light a fire on the high temperature fuse.

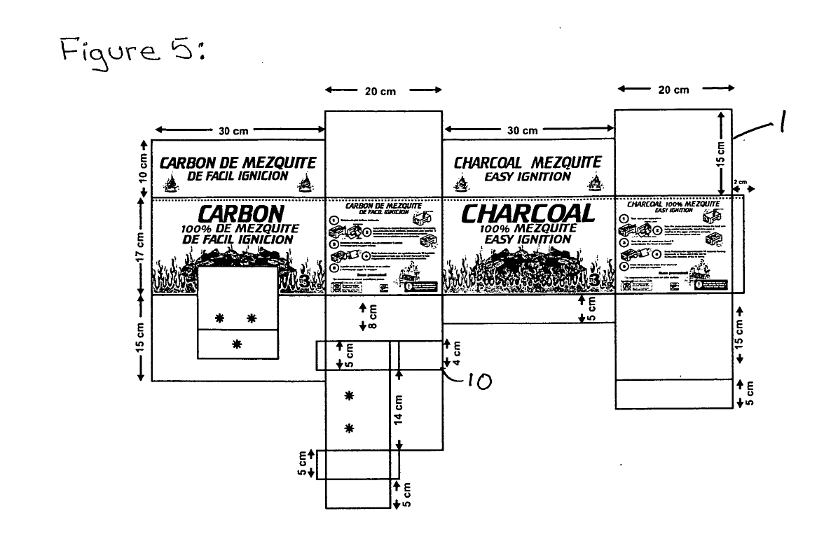

FIG. 4 shows the use of cap 5 generating air through one side of the box 1. Preferably creating air on the side that orifice 15 is located.

FIG. 5 shows the disassembled box 1 with orifice 10 and the most effective dimensions. These dimensions are found to be the dimensions that the market demands but in no way it limits the size of box 1.

### VI. DETAILED DESCRIPTION OF THE PRODUCT AND METHOD

The Easy Starter Charcoal box is intended as an easier, cleaner, simpler, more environmentally friendly, and sensory pleasing method of charcoal packaging and ignition than bagged charcoal/lighter fluid or chemical alternatives.

Once in possession of an Easy Starter Charcoal box remove the top along the perforated lines as shown in FIG. 2. Affix the high temperature fuse included in the box where indicated leaving only ¼ of the fuse visible. (The high temperature fuse will have a measurement between 4 to 14 cm long.) The fuse will be lighted with and external flame (matches, lighter, etc. which are not included in the box). After 5 minutes of lighting the box and approximately every 5 minutes, fan vigorously for 30 seconds or until a flame is achieved using the previously removed lids from the box. Fan directly towards the fuse in order to make the oxygen circulate and encourage and optimal combustion as shown in FIGS. 3 and 4. In approximately, 20 to 25 minutes distribute the lighted charcoal.

### VII. BENEFITS

Ease of transport and handling of charcoal;
A clean and orderly task for effective ignition of product avoiding hands on contact and cooking area;
A fast, easy and effective ignition of product without the use of lighter fluids, which alter the aromas, and flavors of the foods.
Beneficial time saving since the easy and effective ignition produce flames as soon as it is lighted.
It is safe to walk away from the ignited charcoal box in order to focus on other tasks; contact with the smoke is reduced.
The dimensions make it suitable for almost every grill.
Easy correct lighting instructions.
The product is completely consumed leaving very little to no trash.

I claims:

1. A rectangular box comprising of:
a) A cap;
b) A small interior orifice; and
c) a orifice, whereby the cap is placed opposite to the small interior orifice and the orifice is place on one side of sail box.

2. The rectangular box of claim 1 further further comprising a series of orifices located inside the small interior orifice.

3. The rectangular box of claim 2 further comprising means to easily remove said cap.

4. The rectangular box of claim 3 further comprising a series of high temperature fuses with the proper size to be installed through said series of orifices.

5. The rectangular box of claim 4 whereby the box is filled with combustible material.

6. A method to ignite a rectangular box 1 comprising:
a) Removing a cap;
b) Installing a series of high density fuses in through small orifices;
c) Igniting said high density fuses; and
d) With said removed cap creating air to generate extra air flow.
